(19) United States
(12) Patent Application Publication
(10) Pub. No.: US 2025/0370236 A1
(43) Pub. Date: Dec. 4, 2025

(54) DISPLAY DEVICE AND OPTICAL SYSTEM

(71) Applicants: LEMON INC., Grand Cayman (KY); Beijing Zitiao Network Technology Co., Ltd., Beijing (CN)

(72) Inventors: Ziyang ZHANG, Los Angeles, CA (US); Xiaoze OU, Los Angeles, CA (US); Wenbin BAI, Beijing (CN); Xin LI, Beijing (CN); Shaopeng ZHU, Beijing (CN); Yan ZHOU, Beijing (CN); Ling FU, Beijing (CN); Xiaokai LI, Beijing (CN)

(21) Appl. No.: 19/228,276

(22) Filed: Jun. 4, 2025

(30) Foreign Application Priority Data
Jun. 4, 2024 (CN) 202410718420.7

(51) Int. Cl. G02B 17/08; G02B 5/30

(52) U.S. Cl. CPC G02B 17/0808; G02B 5/3025; G02B 5/3083

(57) ABSTRACT

A display device and an optical system are provided, the display device includes a display screen, a lens assembly, a transreflective film, a polarizing reflective layer, a phase delay film. The display surface of the display screen is configured to emit light; the lens assembly is at a side of the display surface emitting light; the lens assembly includes a first surface and a second surface, the first surface is a convex surface, the second surface is at a side of the first surface away from the display surface; the lens assembly includes a third surface, the third surface is located at the side of the second surface away from the first surface; at least a portion of an edge of the first region is adjacent to at least a portion of an edge of the second region; only the second region is provided with a first microstructure.

### CROSS-REFERENCE TO RELATED APPLICATION

The present application claims the priority of the Chinese Patent Application No. 202410718420.7 filed on Jun. 4, 2024, which is incorporated herein by reference as part of the disclosure of the present application.

### TECHNICAL FIELD

At least one embodiment of the present disclosure relates to a display device and an optical system.

### BACKGROUND

A mixed reality (MR) display technology is a visualization technology that integrates virtual and real worlds and can combine digitally generated content with a field of view of a user, to create a mixed reality scene that includes both the real environment and virtual information.

### SUMMARY

At least one embodiment of the present disclosure provides a display device and an optical system.

At least one embodiment of the present disclosure provides a display device, which includes a display screen, comprising a display surface, the display surface is configured to emit light; a lens assembly, located at a side of the display surface emitting light, in which the lens assembly comprises a first surface and a second surface that are arranged in sequence along an optical axis direction of the lens assembly, the first surface is a convex surface, and the second surface is located at a side of the first surface away from the display surface; a transreflective film, located at a side of the first surface away from the second surface; a polarizing reflective layer, located at a side of the second surface away from the first surface; and a phase delay film, located at a side of the first surface away from the transreflective film, in which the lens assembly further comprises a third surface, the third surface is located at the side of the second surface away from the first surface; the third surface comprises a first region and a second region, at least a portion of an edge of the first region is adjacent to at least a portion of an edge of the second region; only the second region is provided with a first microstructure, and the first microstructure is configured to regulate the light; and an orthographic projection of the display surface at least partially overlaps an orthographic projection of the first region on a reference plane perpendicular to the optical axis direction.

For example, according to at least one embodiment of the present disclosure, on the reference plane, the orthographic projection of the first region is located within a range of the orthographic projection of the display surface.

For example, according to at least one embodiment of the present disclosure, the second region surrounds at least a portion of the first region.

For example, according to at least one embodiment of the present disclosure, a ratio between dimensions of portions of a straight line, perpendicular to the optical axis direction and passes through a center of the first region, in the second region at two sides of the first region is 0.9 to 1.1.

For example, according to at least one embodiment of the present disclosure, a ratio of an area of the orthographic projection of the first region on the reference plane to an area of the orthographic projection of the display surface on the reference plane is 0.95 to 1.05.

For example, according to at least one embodiment of the present disclosure, the third surface is a planar structure, or the third surface is a curved structure.

For example, according to at least one embodiment of the present disclosure, the first microstructure comprises a subwavelength structure.

For example, according to at least one embodiment of the present disclosure, the display device further includes a linear polarization film, in which the linear polarization film, the polarizing reflective layer, and the phase delay film are all located between the third surface and the second surface, and the polarizing reflective layer and the phase delay film are both located between the linear polarization film and the second surface.

For example, according to at least one embodiment of the present disclosure, the lens assembly comprises a first lens and a second lens that are arranged along the optical axis direction; the first lens comprises the first surface and the second surface, the second lens is located at the side of the second surface away from the first surface; the second lens comprises the third surface and a fourth surface that are arranged opposite to each other along the optical axis direction, the third surface is a planar structure, and the fourth surface is a plane; and the third surface is located between the second surface and the fourth surface, or the fourth surface is located between the second surface and the third surface.

For example, according to at least one embodiment of the present disclosure, the lens assembly comprises a first lens and a second lens that are arranged along the optical axis direction; the first lens comprises the first surface and the second surface, the second lens is located at the side of the second surface away from the first surface; the second lens comprises the third surface and a fourth surface that are arranged opposite to each other along the optical axis direction, the third surface is a curved structure, and the fourth surface is a curved surface; and the third surface is located between the second surface and the fourth surface, or the fourth surface is located between the second surface and the third surface.

For example, according to at least one embodiment of the present disclosure, the second surface is a concave surface, and there is an air gap between the first lens and the second lens.

For example, according to at least one embodiment of the present disclosure, the second surface is a concave surface, and the display device further comprises an optical medium layer, and the optical medium layer is bonded between the second surface and the second lens; and a refractive index of the optical medium layer is different from that of the first lens.

For example, according to at least one embodiment of the present disclosure, at least a portion of the fourth surface is provided with a second microstructure, and the second microstructure is configured to regulate the light.

For example, according to at least one embodiment of the present disclosure, the second microstructure comprises a subwavelength structure.

For example, according to at least one embodiment of the present disclosure, the lens assembly further comprises a first adhesive layer; the fourth surface is located between the second surface and the third surface, surface parameters of the second surface and the fourth surface are the same, and the first adhesive layer is bonded between the second surface and the fourth surface; and the third surface is located between the second surface and the fourth surface, and the first adhesive layer is bonded between the second surface and the third surface.

For example, according to at least one embodiment of the present disclosure, the second surface is a planar surface or a curved surface; and the lens assembly further comprises a second adhesive layer, a side surface of the second adhesive layer is the third surface, and a side surface of the second adhesive layer facing away from the third surface is adhered to a side surface of an optical film layer away from the display surface.

At least one embodiment of the present disclosure provides an optical system, which includes: a lens assembly, comprising a first surface and a second surface that are arranged in sequence along an optical axis direction of the lens assembly, in which the first surface is a convex surface, and the second surface is a curved surface; a transreflective film, located at a side of the first surface away from the second surface; a polarizing reflective layer, located at a side of the second surface away from the first surface; and a phase delay film, located at a side of the first surface away from the transreflective film, in which the lens assembly further comprises a hypersurface, the hypersurface is located at the side of the second surface away from the first surface; and the hypersurface is configured to regulate light, and the hypersurface is a curved structure.

For example, according to at least one embodiment of the present disclosure, the optical system further includes a linear polarization film; in which the linear polarization film, the polarizing reflective layer, and the phase delay film are all located between the hypersurface and the second surface, and the polarizing reflective layer and the phase delay film are both located between the linear polarization film and the second surface.

At least one embodiment of the present disclosure provides an optical system, which includes: a lens assembly, comprising a first surface and a second surface that are arranged in sequence along an optical axis direction of the lens assembly, and the first surface is a convex surface; a transreflective film, located at a side of the first surface away from the second surface; a polarizing reflective layer, located at a side of the second surface away from the first surface; a phase delay film, located at a side of the first surface away from the transreflective film, in which the lens assembly further comprises a third surface, the third surface is located at the side of the second surface away from the first surface; and the third surface comprises a first region and a second region surrounding at least a portion of the first region, in which only the second region is provided with a microstructure, the microstructure is configured to regulate light emitted from the polarizing reflective layer.

For example, according to at least one embodiment of the present disclosure, an optical axis of the lens assembly passes through the first region.

### BRIEF DESCRIPTION OF DRAWINGS

In order to more clearly explain the technical solution of the embodiments of the present disclosure, the accompanying drawings of the embodiments will be briefly introduced below. Obviously, the accompanying drawings in the following description only relate to some embodiments of the present disclosure, and are not limited to the present disclosure.

FIG. 1 is a schematic diagram of a display device provided by an example in at least one embodiment of the present disclosure.

FIG. 2 is a schematic diagram of a third surface provided by an example in at least one embodiment of the present disclosure.

FIG. 3 is a schematic diagram of a first microstructure provided by an example in at least one embodiment of the present disclosure.

FIG. 4 is a schematic diagram of an orthographic projection of a display surface and an orthographic projection of a first region provided by an example in at least one embodiment of the present disclosure.

FIG. 5 is a schematic diagram in which light is incident on a refractive lens.

FIG. 6 is a schematic diagram in which light is incident on a geometric phase lens.

FIG. 7 to FIG. 9 are schematic diagrams of display devices provided by different examples in at least one embodiment of the present disclosure.

FIG. 10 is a schematic diagram of a fourth surface provided by an example in at least one embodiment of the present disclosure.

FIG. 11 to FIG. 14 are schematic diagrams of display devices provided by different examples in at least one embodiment of the present disclosure.

FIG. 15 is a schematic diagram of an optical system provided by an example in at least one embodiment of the present disclosure.

FIG. 16 is a schematic diagram of an optical system provided by an example in at least one embodiment of the present disclosure.

### DETAILED DESCRIPTION

In order to make the purpose, technical solution and advantages of the embodiment of the present disclosure clearer, the technical solution of the embodiment of the present disclosure will be described clearly and completely with the accompanying drawings. Obviously, the described embodiment is a part of the embodiment of the present disclosure, not the whole embodiment. Based on the described embodiments of the present disclosure, all other embodiments obtained by ordinary skilled in the art without creative labor belong to the scope of protection of the present disclosure.

Unless otherwise defined, technical terms or scientific terms used in the present disclosure shall have their ordinary meanings as understood by people with ordinary skills in the field to which the present disclosure belongs. The terms “first”, “second” and the like used in the present disclosure do not indicate any order, quantity or importance, but are only used to distinguish different components. Similar words such as “including” or “comprising” mean that the elements or objects appearing before the word cover the elements or objects listed after the word and their equivalents, without excluding other elements or objects.

Features such as “vertical”, “parallel”, and “identical” used in the present disclosure all include features such as “vertical”, “parallel”, “identical” in a strict sense, as well as cases such as “roughly vertical”, “roughly parallel”, and “roughly identical” that include a specific error. Considering measurement and errors related to measurement of a specific quantity (i.e., limitations of a measurement system), it indicates that the measurement is within an acceptable deviation range determined by ordinary technical personnel in the field for a specific value. The “center” in the embodiments of the present disclosure may include a position strictly located at the geometric center and a position approximately located at the center within a small region around the geometric center. For example, “roughly” can indicate to be within one or more standard deviations, or within 10% or 5% of the value.

An MR display technology is an advanced technology that combines characteristics of augmented reality (AR) and virtual reality (VR), which allows users to see the real world and computer-generated virtual content that interacts with the real environment. Pixels per degree (PPD) is a key indicator for evaluating visual clarity of head mounted display devices (such as devices in which the MR display technology is used). Therefore, ultra-high definition (PPD>40) is an inevitable development trend for future optical systems.

In the study, the inventor of the present application found that chromatic aberration is a key technical problem that limits the achievement of the ultra-high definition in the MR display technology. The chromatic aberration, such as inter band chromatic aberration and intra band chromatic aberration, is one of important factors affecting performance of optical systems in the MR display technology. Severe chromatic aberration problems can affect edge details and color accuracy of images, and reduce visual clarity of the images.

The chromatic aberration is a specific manifestation of dispersion phenomena in the optical systems, and the dispersion phenomena include material dispersion and structural dispersion. The material dispersion is determined by optical properties of a material. In the case where light of different wavelengths passes through a same material, a difference in refractive index causes the light of the different wavelengths (namely, different colors) to propagate at different speeds inside the material, resulting in separation or differences in focal locations of the light of the different colors in a light beam. For example, a phenomenon of splitting light through a prism is a result of material dispersion. The structural dispersion relates to impact of a geometric structure on light of different wavelengths, such as a size and a shape of the geometric structure, which can cause the light of the different wavelengths to be focused on different focal planes.

Specifically, the chromatic aberration is a common optical defect in optical systems (such as VR devices) and significantly affects image quality. It is a defect in which the light of the different wavelengths is focused at different distances from a lens, resulting in a blurry or distorted image. The chromatic aberration can cause blurring and reduced sharpness at edges of the image, making it difficult to see details and providing a user with immersive experience. The chromatic aberration can also cause different colors to shift from each other, creating a “rainbow” effect at the edges of an object. This distracts attention of the user and reduces a sense of vividness of user experience. Because the chromatic aberration may lead to a blurred image, the user's eye needs to focus harder on the blurred image, resulting in eye fatigue and discomfort for the user, making it difficult for the user to use a VR device for a long period of time. In addition, for an optical system with a large field of view (FOV) and high pixel density, the chromatic aberration has more significant impact on an image.

For example, optical elements of different materials and shapes may be combined, so that light of different wavelengths can be focused on a same focal plane, to reduce or eliminate the chromatic aberration. For example, the chromatic aberration can be reduced or eliminated by an achromatic lens, a non-spherical lens, a diffractive optical element (DOE), or a combination of these optical elements. For example, the achromatic lens is a lens group made of more than two different materials with different dispersion coefficients, and the chromatic aberration in the optical system is reduced by selecting an appropriate combination. For example, ultra-low dispersion glass is a kind of optical glass with a low dispersion property, which has a minimal refractive change for light of different wavelengths and is a good optical material for manufacturing achromatic lenses. A surface curvature of the non-spherical lens is more complex than that of a spherical lens, so that the chromatic aberration can be reduced. The diffractive optical element is an optical element designed and manufactured according to a principle of diffraction of light. It can focus light according to the principle of diffraction, to reduce the chromatic aberration by diffracting light of different wavelengths at different angles.

At least one embodiment of the present disclosure provides a display device, which includes: a display screen, a lens assembly, a transreflective film, a polarizing reflective layer, and a phase delay film. The display screen includes a display surface, and the display surface is configured to emit light. The lens assembly is located at a side of the display surface emitting light, the lens assembly includes a first surface and a second surface that are arranged in sequence along an optical axis direction of the lens assembly, the first surface is a convex surface, and the second surface is located at a side of the first surface away from the display surface; the transreflective film is located at a side of the first surface away from the second surface. The polarizing reflective layer is located at a side of the second surface away from the first surface; the phase delay film is located at a side of the first surface away from the transreflective film; the lens assembly further includes a third surface, and the third surface is located at the side of the second surface away from the first surface. The third surface includes a first region and a second region, at least a portion of an edge of the first region is adjacent to at least a portion of an edge of the second region, only the second region is provided with a first microstructure, and the first microstructure is configured to regulate the light, and an orthographic projection of the display surface at least partially overlaps an orthographic projection of the first region on a reference plane perpendicular to the optical axis direction.

In the display device provided by the embodiment of the present disclosure, a folded optical path can be formed by disposing the polarizing reflective layer, the phase delay film, and the transreflective film mentioned above, to greatly compress space required between a human eye and the display device, so as to make the display device smaller and thinner in size. In addition, the light emitted from the display surface is incident on a region of the first region corresponding to the display surface with a smaller refractive angle, and is incident on the second region not corresponding to the display surface with a larger refractive angle. The first microstructure is disposed on the second region while the first microstructure is not disposed on the first region, so that light emitted from the second region can be regulated by the first microstructure, to reduce chromatic aberration and simplify a design and manufacturing process of the third surface to reduce costs.

At least one embodiment of the present disclosure provides an optical system, which includes: a lens assembly, a transreflective film, a polarizing reflective layer, and a phase delay film. The lens assembly includes a first surface and a second surface that are arranged in sequence along an optical axis direction of the lens assembly, the first surface is a convex surface, and the second surface is a curved surface; the transreflective film is located at a side of the first surface away from the second surface; the polarizing reflective layer is located at a side of the second surface away from the first surface; the phase delay film is located at a side of the first surface away from the transreflective film; the lens assembly further includes a hypersurface, the hypersurface is located at the side of the second surface away from the first surface, the hypersurface is configured to regulate light, and the hypersurface is a curved structure.

In the optical system provided by the embodiment of the present disclosure, a folded optical path can be formed by disposing the polarizing reflective layer, the phase delay film, and the transreflective film mentioned above, to greatly compress a space required between a human eye and a display device, so as to make the display device smaller and thinner in size. In addition, the hypersurface is disposed at the side of the second surface away from the first surface, and light emitted from the polarizing reflective layer is regulated by the hypersurface, so that the chromatic aberration can be reduced. In addition, the hypersurface may be curved and attached to the side of the second surface away from the first surface, to simplify a manufacturing process of the display device to reduce costs.

At least one embodiment of the present disclosure provides an optical system, which includes: a lens assembly, a transreflective film, a polarizing reflective layer, and a phase delay film. The lens assembly includes a first surface and a second surface that are arranged in sequence along an optical axis direction of the lens assembly, and the first surface is a convex surface; the transreflective film is located at a side of the first surface away from the second surface; the polarizing reflective layer is located at a side of the second surface away from the first surface; the phase delay film is located at a side of the first surface away from the transreflective film, the lens assembly further includes a third surface, the third surface is located at the side of the second surface away from the first surface, the third surface includes a first region and a second region surrounding at least a portion of the first region, and no microstructure is disposed on the first region, the microstructure is disposed on the second region, and the microstructure is configured to regulate light emitted from the polarizing reflective layer.

In the optical system provided by the embodiment of the present disclosure, a folded optical path can be formed by disposing the polarizing reflective layer, the phase delay film, and the transreflective film mentioned above, to greatly compress a space required between a human eye and a display device, so as to make the display device smaller and thinner in size. In addition, the microstructure is disposed on the second region while no microstructure is disposed on the first region, so that light emitted from the second region can be regulated by the microstructure, to reduce chromatic aberration and simplify a design and manufacturing process of the third surface to reduce costs.

The display device and the optical system will be described below with reference to the accompanying drawings and by some embodiments.

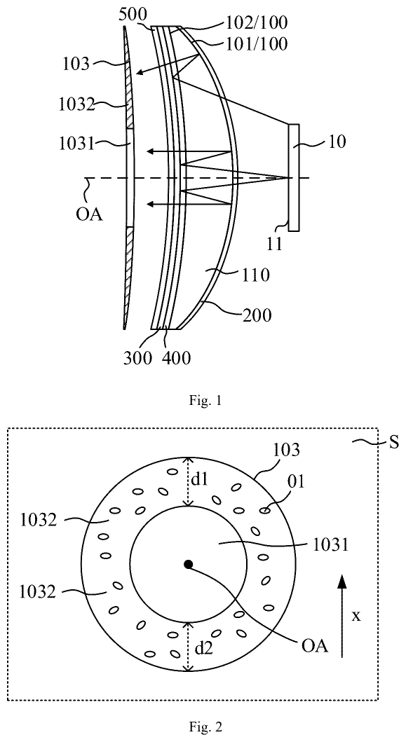

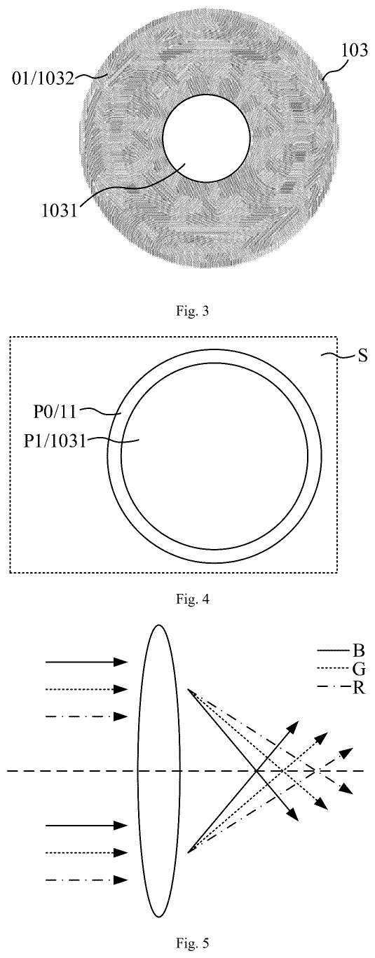

FIG. 1 is a schematic diagram of a display device provided by an example in at least one embodiment of the present disclosure. FIG. 2 is a schematic diagram of a third surface provided by an example in at least one embodiment of the present disclosure. FIG. 3 is a schematic diagram of a first microstructure provided by an example in at least one embodiment of the present disclosure. FIG. 4 is a schematic diagram of an orthographic projection of a display surface and an orthographic projection of a first region provided by an example in at least one embodiment of the present disclosure. FIG. 2 and FIG. 3 only illustrate the third surface and the first microstructure. It can be understood that, the third surface and the first microstructure shown in FIG. 2 and FIG. 3 may be the third surface and the first microstructure in the display device shown in FIG. 1, and the third surface and the first microstructure shown in FIG. 2 and FIG. 3 may also be different from the third surface and the first microstructure in the display device shown in FIG. 1.

Referring to FIG. 1, at least one embodiment of the present disclosure provides a display device, which includes: a display screen 10, a lens assembly 100, a transreflective film 200, a polarizing reflective layer 300, and a phase delay film 400. The display screen 10 includes a display surface 11, and the display surface 11 is configured to emit light; the lens assembly 100 is located at a side of the display surface 11 emitting light, and the lens assembly 100 includes a first surface 101 and a second surface 102 that are arranged in sequence along an optical axis OA direction of the lens assembly 100. For example, the lens assembly 100 may include at least one lens, for example, one lens is shown in FIG. 1. The first surface 101 and the second surface 102 may be two opposite surfaces of a same lens (such as a first lens 110 shown in FIG. 1). For example, the first surface and the second surface may be two surfaces of different lenses, which is not limited in the present disclosure. For example, the lens assembly may include a lens and an adhesive layer, which will be described in detail in the following examples, which are omitted herein in the present disclosure.

Referring to FIG. 1, the first surface 101 is a convex surface, and the second surface 102 is located at a side of the first surface 101 away from the display surface 11. For example, the light emitted from the display surface 11 may be incident from a side of the first surface 101 facing the display surface 11 and exit from a side of the second surface 102 away from the first surface 101.

Referring to FIG. 1, the transreflective film 200 is located at a side of the first surface 101 away from the second surface 102, the polarizing reflective layer 300 is located at the side of the second surface 102 away from the first surface 101, and the phase delay film 400 is located at a side of the first surface 101 away from the transreflective film 200. For example, in the case where the first surface and the second surface are two surfaces of a same lens, the phase delay film may be disposed on the side of the second surface away from the first surface. For example, in the case where the first surface and the second surface are two surfaces of different lenses, the phase delay film may be disposed between the first surface and the second surface. For example, the first surface and the second surface may be different surfaces of two lenses, and the phase delay film may be disposed between the two lenses. For example, light that is incident on the lens assembly 100 after being transmitted by the transreflective film 200 is configured to be refracted between the transreflective film 200 and the polarizing reflective layer 300, and then emitted from the polarizing reflective layer 300, to form a folded optical path by the polarizing reflective layer 300, the transreflective film 200, and the phase delay film 400.

Referring to FIG. 1, for example, the transreflective film 200 is located on the first surface 101 of a convex surface, to facilitate attachment. For example, the transreflective film 200 may transmit a part of light and reflect another part of the light. For example, the transreflective film 200 may be coated on the first surface 101. For example, the polarizing reflective layer 300 is configured to reflect linearly polarized light of one characteristic and transmit linearly polarized light of another characteristic. For example, the phase delay film 400 may be located between the polarizing reflective layer 300 and the first surface 101. For example, the phase delay film may be located at a side of the polarizing reflective layer away from the second surface (not shown in the figure). For example, the phase delay film 400 is configured to enable the transmitted light to achieve a transition between a circular polarization state and a linear polarization state. For example, the phase delay film 400 may be a quarter waveplate.

Referring to FIG. 1 and FIG. 2, the lens assembly 100 further includes a third surface 103. The third surface 103 is located at the side of the second surface 102 away from the first surface 101. The third surface 103 includes a first region 1031 and a second region 1032, at least a portion of an edge of the first region 1031 is adjacent to at least a portion of an edge of the second region 1032. The first region 1031 is adjacent to the second region 1032 means that no other region is disposed between the first region 1031 and the second region 1032, and a boundary of the first region 1031 and a boundary of the second region 1032 are connected. For example, the second region may surround at least a portion of the first region. For example, the first region may be located at a side of the second region.

For example, the third surface may be a surface on the lens. For example, the third surface may be a surface of a thin film structure provided with the first microstructure. For example, a thin film may be attached to a plate glass to support the third surface by the plate glass. For example, the third surface may be formed on the adhesive layer, so that the third surface may be attached to another surface of the lens assembly or an optical film layer in the display device by the adhesive layer. For example, in the case where the optical film layer includes a plurality of film layers, the third surface is attached, through the adhesive layer, to an outermost surface of the optical film layer away from the first lens. A specific embodiment will be described later, which are omitted herein in the present disclosure.

Referring to FIG. 1 to FIG. 3, only the second region 1032 is provided with a first microstructure 01. The first microstructure 01 is configured to regulate light. For example, on the third surface 103, only the second region 1032 is provided with the first microstructure 01, and the first microstructure 01 is not disposed on the first region 1031. For example, the first microstructure may include a two-dimensional subwavelength structure. For example, the subwavelength structure indicates a structure whose characteristic dimension (such as a period, a length, or a width) is smaller than an operating wavelength (which usually indicates an electromagnetic wave, especially a light wave). Dimensions of these structures are usually at a micrometer or nanometer level, and the structures can affect an electromagnetic wave that passes through or propagates near the structures, to regulate at least one selected from the group consisting of a phase, an amplitude, and polarization of light based on a subwavelength scale effect. For example, at least one selected from the group consisting of the polarization, the phase, and the amplitude of the light may be precisely controlled by adjusting parameters such as a shape, a rotation direction, and a height of the first microstructure, to overcome a wavelength dependence problem caused by material dispersion, so that light of different wavelengths can be focused at a same position to reduce chromatic aberration. For example, the polarization of the light may be regulated by the first microstructure. For example, the phase of the light may be regulated by the first microstructure. For example, the amplitude of the light may be regulated by the first microstructure. For example, any two of the polarization, the phase, and the amplitude of the light may be regulated by the first microstructure. For example, the polarization, the phase, and the amplitude of the light may be regulated simultaneously by the first microstructure. For example, a thickness of the third surface 103 provided with the first microstructure 01 may be approximately the same as that of the first microstructure 01.

Referring to FIG. 1 to FIG. 3, for example, since the first microstructure 01 is disposed on the second region 1032 of the third surface 103, the second region 1032 is a three-dimensional structure. For example, the first region 1031 without the first microstructure 01 may be a two-dimensional surface.

Referring to FIG. 1 and FIG. 4, an orthographic projection PO of the display surface 11 at least partially overlaps an orthographic projection P1 of the first region 1031 on a reference plane S perpendicular to the optical axis OA direction. For example, the orthographic projection of the display surface may partially overlap with the orthographic projection of the first region. For example, the orthographic projection of the display surface may fully overlap with the orthographic projection of the first region.

In an optical material, light of different wavelengths (such as different colors) usually have different refractive angles when passing through the same medium. For example, short wavelength light (such as purple light) has a higher refractive index and a smaller refractive angle, while long wavelength light (such as red light) has a lower refractive index and a larger refractive angle. In the case where light is incident at a large angle (refer to FIG. 1), a difference in refractive angle caused by different wavelengths may be more significant. Light of different colors may be focused on different positions after passing through an optical element (such as the lens assembly 100 shown in FIG. 1), resulting in chromatic aberration.

Referring to FIG. 1 to FIG. 4, in the display device, the light emitted from the display surface 11 is incident on a region of the first region 1031 corresponding to the display surface 11 with a smaller refractive angle, and is incident on the second region 1032 not corresponding to the display surface 11 with a larger refractive angle. The first microstructure 01 is disposed on the second region 1032 while the first microstructure 01 is not disposed on the first region 1031, so that light emitted from the second region 1032 can be regulated by the first microstructure 01, to reduce chromatic aberration and simplify a design and the manufacturing process of the third surface 103 to reduce costs.

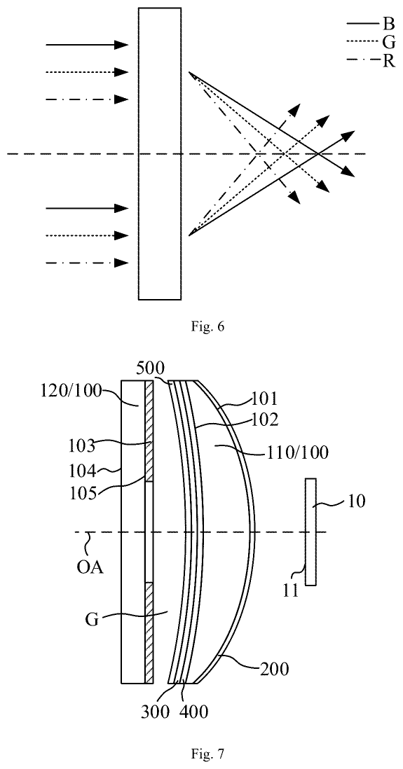

FIG. 5 is a schematic diagram in which light is incident on a refractive lens. FIG. 6 is a schematic diagram in which light is incident on a geometric phase lens.

To better illustrate a principle of regulating light by the first microstructure, the first microstructure is explained with reference to the following examples. For example, a principle of regulating light by the first microstructure on the third surface may be similar to a principle of regulating light by a geometric phase lens (GP Lens). The geometric phase lens adjusts a phase of incident light by an optical structure (such as a geometric phase microstructure) to match a wavefront required by a chromatic aberration curve, so as to control the light and reduce the chromatic aberration. For example, a frequency dependent transmission phase is adjusted by utilizing a resonance characteristic of a geometric phase microstructure, so that wavelengths of all incident light can be focused on a same focal plane, to reduce or eliminate chromatic aberration.

For example, the first microstructure may be similar to a micro-nano structure (such as a nanopillar) on a geometric phase hypersurface of the geometric phase lens. The geometric phase lens, due to a Pancharatnam-Berry (PB phase for short) effect, can cause phase changes and regulate light. The geometric phase lens has a characteristic of a diffractive lens. Specifically, the geometric phase lens has the ability to focus light, similar to a refractive lens, and the geometric phase lens can focus light by changing the wavefront of the light. In addition, referring to FIG. 5, the refractive lens cause light of different wavelengths (such as B light, G light, and R light) to be focused at different positions. A position of a light focal point of short wavelength light (such as Blight) is located in front of a position of a light focal point of long wavelength light (such as R light), which means that positive chromatic aberration is generated. Intuitively, positive chromatic aberration may lead to significant color separation at an edge of an image, that is a red edge and a blue edge are not at a same focal point, resulting in a purple red halo at the edge of the image, which affects imaging quality. Referring to FIG. 6, unlike the refractive lens, after light of different wavelengths (such as B light, G light, and R light) passes through the geometric phase lens, a position of a light focal point of long wavelength light (such as R light) is located in front of a position of a light focal point of short wavelength light (such as B light), which means that the geometric phase lens can generate negative chromatic aberration, and the geometric phase lens can be used to compensate for the chromatic aberration generated by the refractive lens. The positive chromatic aberration of the refractive lens is compensated for through the negative chromatic aberration of the geometric phase lens, so that light focal points of light of different colors are closer, which reduces blur caused by dispersion and make the image clearer.

For example, a subwavelength structure (such as a nanopillar) pattern may be generated on a smooth surface by using a technology such as an electron beam lithography technology and a nanoimprinting technology to form the third surface that includes the first microstructure, so that light is regulated by a structured nanopillar. For example, a birefringent pattern (such as a birefringent structure formed by an arrangement of liquid crystal molecules) may be formed on a smooth surface to form the third surface including the first microstructure. In this way, a polarization state of light passing through the liquid crystal molecules is changed due to a birefringence effect.

Optimization of an optical architecture design including two refractive lenses is used as an example of the lens assembly in the previous example for illustration. The optical architecture including the first refractive lens and the second refractive lens is used as a reference architecture, and the first refractive lens is used as a first lens including the first surface and the second surface. A surface shape of the second refractive lens is used as input, to obtain a second lens including the third surface by designing, and the light refractive ability of a second lens is basically the same as that of the second refractive lens. For example, the ability of the second lens to change a propagation direction of light is essentially the same as that of the second refractive lens. In addition, the second lens including the third surface has a characteristic of negative chromatic aberration, and can be used to compensate for positive chromatic aberration generated by the first refractive lens, to achieve an effect of reducing chromatic aberration or eliminating chromatic aberration.

The second refractive lens is replaced with the second lens, and chromatic aberration of an optical architecture including the first lens and the second lens is calculated. If the chromatic aberration meets a design requirement, the current first lens and the current second lens will be used as the lens assembly. For example, the chromatic aberration generated by the reference architecture (namely, the optical architecture including the first refractive lens and the second refractive lens) is positive chromatic aberration. If the chromatic aberration of the optical architecture including the first lens and the second lens is positive chromatic aberration, it means that the chromatic aberration generated by the first lens has not been completely eliminated, and negative chromatic aberration generated by the second lens has not fully compensated for the positive chromatic aberration generated by the first lens. Therefore, the first microstructure of the third surface needs to be adjusted to adjust the ability of the first microstructure to regulate light. If the chromatic aberration of the optical architecture including the first lens and the second lens is negative chromatic aberration, it means that the negative chromatic aberration generated by the second lens overcompensates for the positive chromatic aberration generated by the first lens, this may be due to excessive compensation of specific chromatic aberration during correction of chromatic aberration, resulting in other chromatic aberration becoming significant, in this case, the first microstructure of the third surface needs to be adjusted to adjust the ability of the first microstructure to regulate light. The above steps are repeated until the chromatic aberration of the optical architecture including the first lens and the second lens is zero. Thus, through iterative optimization, a compensation degree of the lens assembly for the chromatic aberration can reach an optimal balance point, to achieve collaborative optimization of the display device. For example, the display device including the second lens including the third surface can achieve a zero dispersion effect, that is, through a collaborative effect of various surfaces in the lens assembly, light of different wavelengths emitted from a display surface of a display screen has a same propagation speed or phase speed, and is focused at a same position to improve clarity of an image.

Referring to FIG. 1, in some examples, the display device further includes a linear polarization film 500. The linear polarization film 500, the polarizing reflective layer 300, and the phase delay film 400 are all located between the third surface 103 and the second surface 102, and the polarizing reflective layer 300 and the phase delay film 400 are both located between the linear polarization film 500 and the second surface 102. For example, the linear polarization film may be a linear polarizer or polarizer. For example, a light transmission axis of the linear polarization film 500 may coincide with a light transmission axis of the polarizing reflective layer 300. For example, the linear polarization film 500 may be used to further filter other stray light, and only allow polarized light (such as s-linearly polarized light) passing through the linear polarization film 500 to enter a human eye. For example, the linear polarization film may adopt a three-layer structure, in which a middle layer in the three-layer structure may be polyvinyl alcohol (PVA) added with dichroic molecules, and at least one layer on two sides of the middle layer in the three-layer structure may be cellulose triacetate (TAC).

For example, referring to FIG. 1, in the display device, a folded optical path principle is as follows: a waveplate may be disposed at a light-emitting side of the display screen 10 located at a side of the first surface 101 away from the second surface 102. Image light emitted from the display surface 11 of the display screen 10 is converted into right-handed circularly polarized light after passing through the waveplate, and a polarization state of the right-handed circularly polarized light remains unchanged after being transmitted through the transreflective film 200. After transmission, the light reaches the phase delay film 400, and the right-handed circularly polarized light incident on the phase delay film 400 is converted into p-linearly polarized light. The p-linearly polarized light is reflected back to the phase delay film 400 by the polarizing reflective layer 300, in which the first reflection occurs. Then, the p-linearly polarized light is converted into right-handed circularly polarized light after passing through the phase delay film 400. The right-handed circularly polarized light reaches the transreflective film 200 after being transmitted, and is reflected at the transreflective film 200, in which the second reflection occurs. Due to half-wave loss, the reflected light changes from the right-handed circularly polarized light to the left-handed circularly polarized light. The left-handed circularly polarized light reaches the phase delay film 400 after transmission, and becomes S-linearly polarized light after transmission through the phase delay film 400, and then the S-linearly polarized light is transmitted through the polarizing reflective layer 300 and then emitted to an exit pupil like a human eye.

The above-mentioned folded optical path may change a polarization state of light propagating between the polarizing reflective layer 300 and the transreflective film 200, which achieves the folding of the light, so that an original focal length of the display device is folded due to, for example, two times of reflection increased by disposing the polarizing reflective layer 300, the phase retardation film 400, and the transreflective film 200, to greatly compress a space required between the human eye and the display device, and make the display device smaller in size and lighter.

Referring to FIG. 1 and FIG. 4, in some examples, on the reference plane S, an orthographic projection P1 of the first region 1031 is located within a range of an orthographic projection PO of the display surface 11. For example, referring to FIG. 4, the orthographic projection PO of the display surface 11 may surround the orthographic projection P1 of the first region 1031. For example, the orthographic projection of the display surface may completely coincide with the orthographic projection of the first region. Thus, light with a larger deflection angle emitted from the display surface 11 may be regulated by the first microstructure 01 disposed on the second region 1032, while no first microstructure 01 is disposed on the first region 1031 to simplify the manufacturing process.

Referring to FIG. 1 and FIG. 2, in some examples, the second region 1032 surrounds at least a portion of the first region 1031. For example, the display surface 11 is on an optical axis OA, and the first region 1031 corresponding to the display surface 11 is located in a central region of the third surface 103, so that the second region 1032 surrounds the first region 1031. For example, in the case where the orthographic projection of the first region partially overlaps with the orthographic projection of the display surface, an orthographic projection of the second region partially overlaps with the orthographic projection of the display surface.

Referring to FIG. 1 and FIG. 2, in some examples, a ratio between dimensions d1 and d2 of portions of a straight line, perpendicular to the optical axis OA direction and passes through a center of the first region 1031, in the second region 1032 at two sides of the first region 1031 is 0.9 to 1.1. For example, the dimensions d1 and d2 of the portions of a straight line, perpendicular to the optical axis OA direction and passes through a center of the first region 1031, in the second region 1032 at two sides of the first region 1031 are basically equal.

For example, the center of the first region 1031 indicates a geometric center of the first region. For example, in the case where an outer contour shape of the first region 1031 is a circle, the center of the first region 1031 is a center of the circle. For example, in the case where the outer contour shape of the first region 1031 and an outer contour shape of the second region 1032 are both circular, centers of the two circles coincide, so that the dimensions d1 and d2 are basically equal. For example, the second region is in the shape of a circular ring, and a width of the circular ring is equal everywhere. For example, in the case where the outer contour shape of the first region is a rectangle, the center of the first region is a center of the rectangle, namely, an intersection point of diagonal lines of the rectangle. For example, in the case where the outer contour shape of the first region and the outer contour shape of the second region each are both rectangular, centers of the two rectangles coincide. For example, the shape of the second region is a square ring shape. For example, the outer contour shape of one of the first region and second region is a circle, while the outer contour shape of the other is a rectangle, and a center of the rectangle may coincide with a center of the circle. Of course, the outer contour shape of the first region and the outer contour shape of the second region may also be other regular closed shapes or irregular closed shapes. The outer contour shape of the first region and the outer contour shape of the second region may be similar shapes, and the outer contour shape of the first region and the outer contour shape of the second region may also be different, which is not limit in the present disclosure.

Referring to FIG. 1 and FIG. 4, in some examples, a ratio of an area of the orthographic projection P1 of the first region 1031 to an area of the orthographic projection PO of the display surface 11 is 0.95 to 1.05. For example, the ratio of the area of the orthographic projection of the first region to the area of the orthographic projection of the display surface may be 0.95 to 1. For example, the ratio of the area of the orthographic projection of the first region to the area of the orthographic projection of the display surface may be 1 to 1.05. Of course, the area of the first region may alternatively be set smaller, as long as light emitted from the display surface can be regulated by the first microstructure disposed on the second region, which is not limited in the present disclosure.

For example, referring to FIG. 4, an outer contour shape of the orthographic projection PO of the display surface 11 may be a circle, and an outer contour shape of the orthographic projection P1 of the first region 1031 may be a circle. For example, the outer contour shape of the orthographic projection of the display surface may be a rectangle, and the outer contour shape of the orthographic projection of the first region may be a rectangle. Of course, the outer contour shape of the orthographic projection of the display surface and the outer contour shape of the orthographic projection of the first region may alternatively be other shapes, which is not limited in the present disclosure.

In some examples, the third surface is a planar structure, or alternatively, the third surface is a curved structure (referring to FIG. 1). For example, the third surface provided with the first microstructure may be roughly planar as a whole. For example, the third surface provided with the first microstructure may be roughly convex as a whole. For example, the third surface provided with the first microstructure may be roughly concave as a whole.

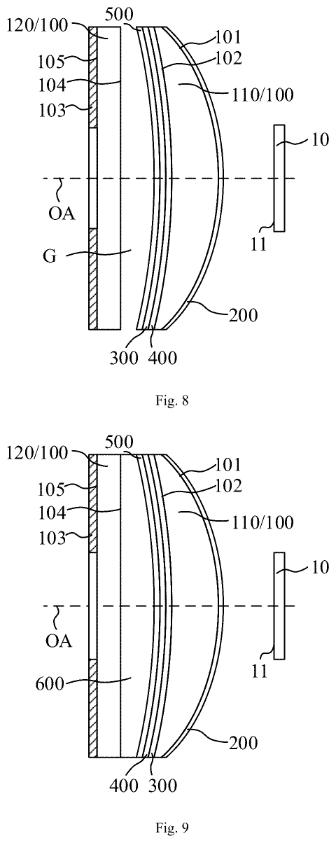

FIG. 7 and FIG. 8 are schematic diagrams of display devices provided by different examples in at least one embodiment of the present disclosure. A difference between the display device shown in FIG. 7 and the display device shown in FIG. 8 is that a relative location relationship between the third surface 103 and the fourth surface 104 in the display device shown in FIG. 7 is different from a relative location relationship between the third surface 103 and the fourth surface 104 in the display device shown in FIG. 8. The transreflective film 200, the polarizing reflective layer 300, the phase delay film 400, and the linear polarization film 500 in the display devices shown in FIG. 7 and FIG. 8 may all have same features as the transreflective film 200, the polarizing reflective layer 300, the phase delay film 400, and the linear polarization film 500 in the display device described in FIG. 1, which are omitted herein in the present disclosure.

Referring to FIG. 7 and FIG. 8, in some examples, the lens assembly 100 includes a first lens 110 and a second lens 120 that are arranged along an optical axis OA direction. The first lens 110 includes a first surface 101 and a second surface 102, and the second lens 120 is located at a side of the second surface 102 away from the first surface 101. The second lens 120 includes a third surface 103 and a fourth surface 104 that are arranged opposite to each other along the optical axis OA direction. An optical film layer such as the linear polarization film 500, the transreflective film 200, the polarizing reflective layer 300, or the phase delay film 400 may be attached to the first lens 110, so that light emitted from the display surface 11 passes through the third surface 103 after being emitted from the polarizing reflective layer 300, to regulate the light by the first microstructure on the third surface 103 to reduce chromatic aberration.

Referring to FIG. 7 and FIG. 8, in some examples, the third surface 103 is a planar structure and the fourth surface 104 is a plane. For example, the third surface and the fourth surface may be two opposite surfaces of the second lens along the optical axis direction, and the overall shape of the third surface provided with the first microstructure is a plane.

Referring to FIG. 7, in some examples, the third surface 103 is located between the second surface 102 and the fourth surface 104. For example, the third surface 103 may be located at a side of the second lens 120 close to the first lens 110. Referring to FIG. 8, in some examples, the fourth surface 104 is located between the second surface 102 and the third surface 103, that is, the third surface 103 may be located at a side of the second lens 120 away from the first lens 110. It can be understood that, as long as light emitted from the polarizing reflective layer 300 can pass through the third surface 103 and be regulated by the first microstructure 01 on the third surface 103 to reduce the chromatic aberration, and a location of the third surface is not limited in the present disclosure.

Referring to FIG. 8, in some examples, the second surface 102 is a concave surface, and there is an air gap G between the first lens 110 and the second lens 120. For example, the air gap is a gap formed by air. A refractive index of the air gap G is different from that of the first lens 110. For example, a refractive index of the air is lower than that of the first lens, so by combining a difference in refractive index with the first microstructure 01 on the third surface 103, the chromatic aberration can be reduced. In addition, a degree of design freedom of the first lens 110 and the second lens 120 is improved by disposing the air gap G. For example, in the case where the fourth surface 104 is a planar surface and the second surface 102 is a concave surface, the air gap G is an optical interlayer with planar and convex surfaces, which is not limited in embodiments of the present disclosure. In the case where the third surface and the fourth surface are curved surfaces and the second surface is a concave surface, the air gap may be an optical interlayer with a concave surface and a convex surface, or the air gap may be an optical interlayer with two convex surfaces.

FIG. 9 is a schematic diagram of a display device provided by an example in at least one embodiment of the present disclosure. A difference between the display device shown in FIG. 9 and the display device shown in FIG. 8 is that the air gap G is provided between the first lens 110 and the second lens 120 in FIG. 8, and an optical medium layer 600 is disposed between the first lens 110 and the second lens 120 in FIG. 9. The transreflective film 200, the polarizing reflective layer 300, the phase delay film 400, and the linear polarization film 500 in the display devices shown in FIG. 9 may all have the same features as the transreflective film 200, the polarizing reflective layer 300, the phase delay film 400, and the linear polarization film 500 in the display device described in FIG. 1, which are omitted herein in the present disclosure.

Referring to FIG. 9, in some examples, the second surface 102 is a concave surface, and the display device further includes an optical medium layer 600, the optical medium layer 600 is bonded between the second surface 102 and the second lens 120. For example, the optical medium layer may be a lens or an adhesive layer. A refractive index of the optical medium layer 600 is different from a refractive index of the first lens 110, so by combining a difference in refractive index with the first microstructure 01 on the third surface 103, the chromatic aberration can be reduced. For example, the refractive index of the optical medium layer may be greater than the refractive index of the first lens. For example, the refractive index of the optical medium layer may be smaller than the refractive index of the first lens. For example, surface shapes of two surfaces, arranged along the optical axis OA, of the optical medium layer 600 may be designed based on surface shapes of the first lens 110 and the second lens 120. For example, a surface of the optical medium layer 600 facing the second surface 102 may have a same surface shape parameter as that of the second surface 102. For example, in the case where the fourth surface 104 is located at a side of the second lens 120 facing the first lens 110, a side surface of the optical medium layer 600 bonded to the fourth surface 104 may have a same surface shape parameter as that of the fourth surface 104. For example, in the case where the fourth surface 104 is a planar surface and the second surface 102 is a concave surface, the optical medium layer 600 is an optical interlayer with the planar surface and the convex surface.

For example, in the case where the third surface is located at the side of the second lens facing the first lens, a side surface of the optical medium layer facing the third surface may be complementary to the third surface. For example, in the case where the third surface is a curved structure, the fourth surface is a curved surface, and the second surface is a concave surface, the optical medium layer may be an optical interlayer with a concave surface and a convex surface, or the optical medium layer may be an optical interlayer with two convex surfaces.

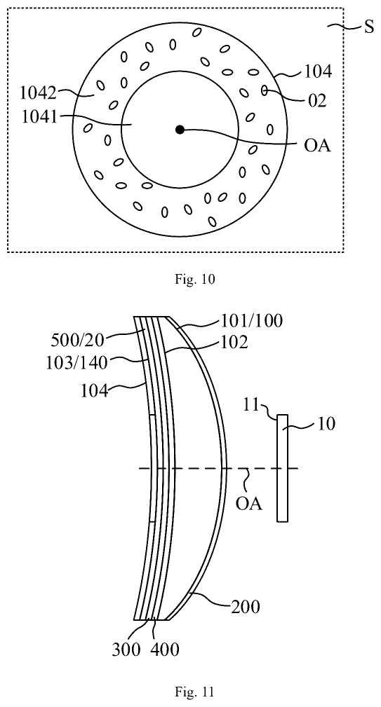

FIG. 10 is a schematic diagram of a fourth surface provided by an example in at least one embodiment of the present disclosure.

Referring to FIG. 2 and FIG. 10, in some examples, at least a portion position of the fourth surface 104 is provided with a second microstructure 02, and the second microstructure 02 is configured to regulate the light. For example, the second microstructure 02 may include a subwavelength structure. For example, a principle of regulating the light by the second microstructure 02 may be the same as a principle of regulating the light by the first microstructure 01. For example, the principle of regulating the light by the second microstructure 02 may alternatively be different from the principle of regulating the light by the first microstructure 01, so that the functions of the second microstructure 02 and the first microstructure 01 may be different, to implement more complex or efficient optical operations. For example, the fourth surface provided with the second microstructure 02 may be a three-dimensional structure. For example, a thickness of the fourth surface 104 may be substantially the same as that of the second microstructure 02.

Referring to FIG. 10, for example, the fourth surface 104 includes a third region 1041 and a fourth region 1042. At least a portion of an edge of the third region 1041 is adjacent to at least a portion of an edge of the fourth region 1042. Only the fourth region 1042 is provided with the second microstructure 02, which simplifies the manufacturing process, reduces the costs, and regulates light in a region on which the light is incident at a larger incident angle by the second microstructure 02. For example, in other words, no other region is disposed between the third region 1041 and the fourth region 1042, and a boundary of the third region 1041 and a boundary of the fourth region 1042 are connected. For example, on the fourth surface 104, only the fourth region 1042 is provided with the second microstructure 02, and no second microstructure 02 is disposed on the third region 1041. Referring to FIG. 2 and FIG. 10, on the reference plane S, an orthographic projection of the third region 1041 may at least partially overlap with an orthographic projection of the first region 1031, and an orthographic projection of the fourth region 1042 may at least partially overlap with an orthographic projection of the second region 1032. For example, the third region 1041 may correspond to the first region 1031, and the fourth region 1042 may correspond to the second region 1032. For example, the second microstructure 02 on the fourth region 1042 may cooperate with the first microstructure 01 on the second region 1032 to jointly regulate light to reduce chromatic aberration.

For example, the second microstructure may be disposed on only the third region, so that light in a region on which the light is incident at a larger incident angle is regulated by the first microstructure on the third surface, and light in a region corresponding to the display surface is regulated by the second microstructure on the fourth surface, to reduce chromatic aberration through the cooperation of the first microstructure and the second microstructure. For example, the fourth surface may alternatively be a hypersurface (such as a geometric phase hypersurface), that is, second microstructures are disposed on both the third region and the fourth region of the fourth surface, which is not limited in the present disclosure.

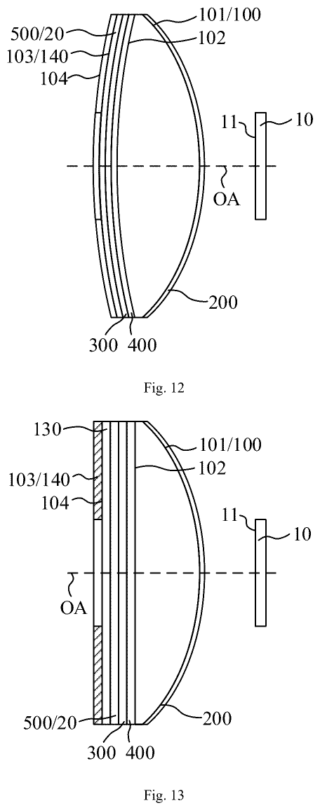

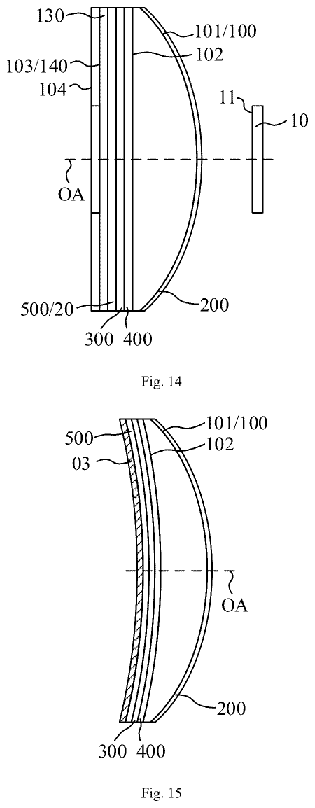

FIG. 11 to FIG. 14 are schematic diagrams of display devices provided by different examples in at least one embodiment of the present disclosure. A difference among the display devices shown in FIG. 11 to FIG. 13 is that surface shape parameters of the second surfaces 102 of the display devices shown in FIG. 11 and FIG. 12 are different from those of the second surfaces 102 of the display devices shown in FIG. 13 and FIG. 14. Of course, there may alternatively be another difference among the display devices shown in FIG. 11 to FIG. 14. For example, the display devices shown in FIG. 13 and FIG. 14 both show a first adhesive layer 130. For example, a relative position relationship between the third surface 103 and the fourth surface 104 in the display device shown in FIG. 13 is different from a relative position relationship between the third surface 103 and the fourth surface 104 in the display device shown in FIG. 14. The transreflective film 200, the polarizing reflective layer 300, the phase delay film 400, and the linear polarization film 500 in the display devices shown in FIG. 11 to FIG. 14 may all have same features as the transreflective film 200, the polarizing reflective layer 300, the phase delay film 400, and the linear polarization film 500 in the display device shown in FIG. 1, which are omitted herein in the present disclosure.

Referring to FIG. 11 and FIG. 12, in some examples, the third surface 103 is a curved structure and the fourth surface 104 is a curved surface. For example, the third surface 103 is a curved structure, and a curved surface on the curved structure may bend in a same direction as the fourth surface 104. For example, referring to FIG. 11, the third surface 103 may be a convex structure, and the fourth surface 104 may be a concave surface. For example, referring to FIG. 12, the third surface 103 may be a concave structure, and the fourth surface 104 may be a convex surface.

For example, in the case where the third surface and the fourth surface are two opposite surfaces on a second lens, a lens with a hyperbolic surface may be manufactured, and the first microstructure may be processed on a smooth surface to form the third surface, to form the second lens. For example, in the case where the third surface is a surface of a thin film, the thin film may be attached to the hyperbolic lens, so that a lens surface supports the third surface on the thin film.

For example, referring to FIG. 13, the third surface 103 may be a planar structure, and the fourth surface 104 may be a plane. For example, the second surface 102 may be a plane. For example, optical film layers 20 such as the linear polarization film 500, the polarizing reflective layer 300, and the phase delay film 400 are further disposed on a side of the second surface 102 facing the fourth surface 104. The fourth surface 104 may be adhered to and conformal to a side surface of the optical film layer 20 (for example, the linear polarization film 500) away from the second surface 102.

Referring to FIG. 13, in some examples, the lens assembly 100 further includes a first adhesive layer 130. The fourth surface 104 is located between the second surface 102 and the third surface 103, surface parameters of the second surface 102 and the fourth surface 104 are the same, and the first adhesive layer 130 is bonded between the second surface 102 and the fourth surface 104. For example, the surface parameters of the second surface 102 and the fourth surface 104 may be set to be the same to reduce a material for the first adhesive layer 130. For example, the optical film layers 20 such as the linear polarization film 500, the polarizing reflective layer 300, and the phase delay film 400 are further disposed between the second surface 102 and the fourth surface 104. The first adhesive layer 130 may be bonded between the side surface of the optical film layer 20 away from the second surface 102 and the fourth surface 104. For example, the first adhesive layer 130 may be bonded between the side surface of the linear polarization film 500 facing the fourth surface 104 and the fourth surface 104.

Referring to FIG. 14, in some examples, the third surface 103 is located between the second surface 102 and the fourth surface 104, and the first adhesive layer 130 is bonded between the second surface 102 and the third surface 103. For example, the optical film layers 20 such as the linear polarization film 500, the polarizing reflective layer 300, and the phase delay film 400 are further disposed between the second surface 102 and the third surface 103. The first adhesive layer 130 may be bonded between the side surface of the optical film layer 20 away from the second surface 102 and the third surface 103. For example, the first adhesive layer 130 may be bonded between the side surface of the linear polarization film 500 facing the third surface 103 and the third surface 103.

Referring to FIG. 11 and FIG. 12, in some examples, the second surface 102 is a curved surface. For example, the second surface 102 may be a convex surface or a concave surface. Referring to FIG. 13 and FIG. 14, in some examples, the second surface 102 is a plane. Referring to FIG. 11 to FIG. 14. The lens assembly 100 further includes a second adhesive layer 140, and one side surface of the second adhesive layer 140 is the third surface 103. Referring to FIG. 13, a side surface (such as the fourth surface 104) of the second adhesive layer 140 facing away from the third surface 103 is adhered to a side surface of the optical film layer 20 away from the display surface 11. For example, the third surface 103 may be formed on the second adhesive layer 140, and an adhesive side surface (such as the fourth surface 104) of the second adhesive layer 140 away from the third surface 103 is adhered to the optical film layer. For example, in the case where the optical film layer 20 is disposed on a side of the first lens 110 facing the second lens 120, the second adhesive layer 140 may be attached to a side surface of the optical film layer 20 away from the first lens 110. For example, in the case where the optical film layer includes a plurality of film layers, the second adhesive layer is attached to an outermost surface of the optical film layer away from the first lens. For example, in the case where the optical film layer only includes the phase delay film and the polarizing reflective layer, and the polarizing reflective layer is located on a side of the phase delay film away from the second surface, the second adhesive layer may be attached to a side of the polarizing reflective layer away from the second surface. For example, in the case where the optical film layer only includes the phase delay film and the polarizing reflective layer, and the phase delay film is located at a side of the polarizing reflective layer away from the second surface, the second adhesive layer may be attached to a side of the phase delay film away from the second surface. For example, the optical film layer 20 includes the polarizing reflective layer 300, the phase delay film 400, and the linear polarization film 500. Both the polarizing reflective layer 300 and the phase delay film 400 are located between the linear polarization film 500 and the second surface 102. Therefore, the second adhesive layer 140 may be attached to a side of the linear polarization film 500 away from the second surface 102. It can be understood that, due to a flexible material of the second adhesive layer 140, a surface shape of the second adhesive layer 140 may be conformal to the second surface 102.

FIG. 15 is a schematic diagram of an optical system provided by an example in at least one embodiment of the present disclosure.

Referring to FIG. 15, at least one embodiment of the present disclosure provides an optical system that are arranged in sequence along an optical axis OA direction of the lens assembly 100, the first surface 101 is a convex surface, and the second surface 102 is a curved surface. For example, the second surface may be a convex surface or a concave surface. A transreflective film 200 is located at a side of the first surface 101 away from the second surface 102, a polarizing reflective layer 300 is located at a side of the second surface 102 away from the first surface 101, and a phase delay film 400 is located at a side of the first surface 101 away from the transreflective film 200. For example, for the relevant descriptions of the transreflective film 200, the polarizing reflective layer 300, and the phase delay film 400, refer to the descriptions in the previous embodiments, which are omitted herein.

Referring to FIG. 15, in some examples, the lens assembly 100 further includes a hypersurface 03. The hypersurface 03 is located at a side of the second surface 102 away from the first surface 101. The hypersurface 03 is configured to regulate light, and the hypersurface 03 is a curved structure. The hypersurface 03 is disposed at the side of the second surface 102 away from the first surface 101, and light emitted from the polarizing reflective layer 300 is regulated by the hypersurface 03, so that chromatic aberration can be reduced. In addition, the hypersurface 03 may be curved and attached to the side of the second surface 102 away from the first surface 101, to simplify a manufacturing process of a display device to reduce costs. For example, the hypersurface is a three-dimensional structure. The hypersurface may be a surface of a lens or a surface of a thin film.

For example, the hypersurface may be a geometric phase hypersurface. The geometric phase hypersurface is a hypersurface composed of identical artificial microstructures with different rotation angles. Phase transition of light waves may be implemented by simply changing a rotation angle of a micro-nano structure (such as a nanopillar), to implement manual control of phase gradient or distribution. Therefore, this greatly reduces the complexity of designing and processing a hypersurface. The geometric phase hypersurface fully utilizes a degree of freedom of a “geometric phase” to achieve a large quantity of spin-dependent electromagnetic wave regulation phenomena.

Referring to FIG. 15, in some examples, the optical system further includes a linear polarization film 500. The linear polarization film 500, the polarizing reflective layer 300, and the phase delay film 400 are all located between the hypersurface 03 and the second surface 102, and the polarizing reflective layer 300 and the phase delay film 400 are both located between the linear polarization film 500 and the second surface 102. For example, the hypersurface 03 may be attached to a side surface of the polarizing film 500 away from the second surface 102. For example, for the relevant descriptions of the linear polarization film, referring to the descriptions in the previous embodiments, which are omitted herein in the present disclosure.

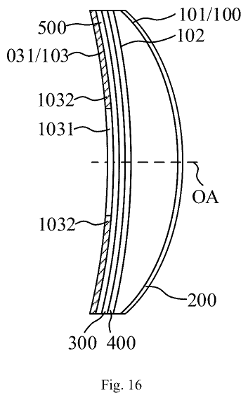

FIG. 16 is a schematic diagram of an optical system provided by an example in at least one embodiment of the present disclosure.

Referring to FIG. 16, at least one embodiment of the present disclosure provides an optical system that are arranged in sequence along an optical axis OA direction of the lens assembly 100, and the first surface 101 is a convex surface. A transreflective film 200 is located at a side of the first surface 101 away from the second surface 102, a polarizing reflective layer 300 is located at the side of the second surface 102 away from the first surface 101, and a phase delay film 400 is located at a side of the first surface 101 away from the transreflective film 200. The lens assembly 100 further includes a third surface 103. The third surface 103 is located at the side of the second surface 102 away from the first surface 101. The third surface 103 includes a first region 1031 and a second region 1032 surrounding at least a portion of the first region 1031, where a microstructure 031 is disposed on only the second region 1032, the microstructure 031 is configured to regulate light emitted from the polarizing reflective layer 300.

Referring to FIG. 16, the microstructure 031 is disposed on the second region 1032 while no microstructure 031 is disposed on the first region 1031, so that light emitted from the second region 1032 can be regulated by the microstructure 031, to reduce chromatic aberration and simplify a design and manufacturing process of the third surface 103 to reduce costs. For example, regulating the light by the microstructure 031 may be the same as regulating the light by the first microstructure (referring to FIG. 1 to FIG. 3) in the previous embodiments, which are omitted herein in the present disclosure. For example, the third surface 103 provided with the microstructure 031 may be a three-dimensional structure.

In some examples, an optical axis OA of the lens assembly 100 passes through the first region 1031. For example, the optical system may be used in a display device with a coaxial design, where the optical axis OA passes through the lens assembly 100 and a center of a display surface, to ensure that light propagates directly along the optical axis OA direction. As a result, a refractive angle of the light emitted from the display surface 1031 is small when the light is incident on the first region, while a refractive angle of the light incident on the second region 1032 is large. The microstructure 031 is disposed on only the second region 1032, so that light can be regulated by the microstructure 031 on the second region 1032. In this way, light with a large refractive angle can also be focused at a same location to reduce chromatic aberration.

The following statements should be noted:
(1) The accompanying drawings involve only the structure(s) in connection with the embodiment(s) of the present disclosure, and other structure(s) can be referred to common design(s).
(2) In case of no conflict, the embodiments of the present disclosure and the features in the embodiments can be combined with each other to obtain new embodiments.

The above is only the specific embodiment of the present disclosure, but the protection scope of the present disclosure is not limited to this, and the scope of protection of the present disclosure should be based on the scope of protection of the claims.

1. A display device, comprising:
a display screen, comprising a display surface, wherein the display surface is configured to emit light;
a lens assembly, located at a side of the display surface emitting light, wherein the lens assembly comprises a first surface and a second surface that are arranged in sequence along an optical axis direction of the lens assembly, the first surface is a convex surface, and the second surface is located at a side of the first surface away from the display surface;
a transreflective film, located at a side of the first surface away from the second surface;
a polarizing reflective layer, located at a side of the second surface away from the first surface; and
a phase delay film, located at a side of the first surface away from the transreflective film,
wherein the lens assembly further comprises a third surface, the third surface is located at the side of the second surface away from the first surface;
the third surface comprises a first region and a second region, at least a portion of an edge of the first region is adjacent to at least a portion of an edge of the second region; only the second region is provided with a first microstructure, and the first microstructure is configured to regulate the light; and
an orthographic projection of the display surface at least partially overlaps an orthographic projection of the first region on a reference plane perpendicular to the optical axis direction.

2. The display device according to claim 1, wherein on the reference plane, the orthographic projection of the first region is located within a range of the orthographic projection of the display surface.

3. The display device according to claim 1, wherein the second region surrounds at least a portion of the first region.

4. The display device according to claim 3, wherein a ratio between dimensions of portions of a straight line, perpendicular to the optical axis direction and passes through a center of the first region, in the second region at two sides of the first region is 0.9 to 1.1.

5. The display device according to claim 1, wherein a ratio of an area of the orthographic projection of the first region on the reference plane to an area of the orthographic projection of the display surface on the reference plane is 0.95 to 1.05.

6. The display device according to claim 1, wherein the third surface is a planar structure, or the third surface is a curved structure.

7. The display device according to claim 1, wherein the first microstructure comprises a subwavelength structure.

8. The display device according to claim 1, further comprising a linear polarization film, wherein the linear polarization film, the polarizing reflective layer, and the phase delay film are all located between the third surface and the second surface, and the polarizing reflective layer and the phase delay film are both located between the linear polarization film and the second surface.

9. The display device according to claim 1, wherein the lens assembly comprises a first lens and a second lens that are arranged along the optical axis direction;
the first lens comprises the first surface and the second surface, the second lens is located at the side of the second surface away from the first surface;
the second lens comprises the third surface and a fourth surface that are arranged opposite to each other along the optical axis direction, the third surface is a planar structure, and the fourth surface is a plane; and
the third surface is located between the second surface and the fourth surface, or the fourth surface is located between the second surface and the third surface.

10. The display device according to claim 1, wherein the lens assembly comprises a first lens and a second lens that are arranged along the optical axis direction;
the first lens comprises the first surface and the second surface, the second lens is located at the side of the second surface away from the first surface;
the second lens comprises the third surface and a fourth surface that are arranged opposite to each other along the optical axis direction, the third surface is a curved structure, and the fourth surface is a curved surface; and
the third surface is located between the second surface and the fourth surface, or the fourth surface is located between the second surface and the third surface.

11. The display device according to claim 9, wherein the second surface is a concave surface, and there is an air gap between the first lens and the second lens.

12. The display device according to claim 9, wherein the second surface is a concave surface, and the display device further comprises an optical medium layer, and the optical medium layer is bonded between the second surface and the second lens; and
a refractive index of the optical medium layer is different from that of the first lens.

13. The display device according to claim 9, wherein at least a portion of the fourth surface is provided with a second microstructure, and the second microstructure is configured to regulate the light.

14. The display device according to claim 13, wherein the second microstructure comprises a subwavelength structure.

15. The display device according to claim 10, wherein the lens assembly further comprises a first adhesive layer;
the fourth surface is located between the second surface and the third surface, surface parameters of the second surface and the fourth surface are the same, and the first adhesive layer is bonded between the second surface and the fourth surface; and
the third surface is located between the second surface and the fourth surface, and the first adhesive layer is bonded between the second surface and the third surface.

16. The display device according to claim 1, wherein the second surface is a planar surface or a curved surface; and
the lens assembly further comprises a second adhesive layer, a side surface of the second adhesive layer is the third surface, and a side surface of the second adhesive layer facing away from the third surface is adhered to a side surface of an optical film layer away from the display surface.

17. An optical system comprising:
a lens assembly, comprising a first surface and a second surface that are arranged in sequence along an optical axis direction of the lens assembly, wherein the first surface is a convex surface, and the second surface is a curved surface;
a transreflective film, located at a side of the first surface away from the second surface;
a polarizing reflective layer, located at a side of the second surface away from the first surface; and
a phase delay film, located at a side of the first surface away from the transreflective film,
wherein the lens assembly further comprises a hypersurface, the hypersurface is located at the side of the second surface away from the first surface; and
the hypersurface is configured to regulate light, and the hypersurface is a curved structure.

18. The optical system according to claim 17, further comprising a linear polarization film;
wherein the linear polarization film, the polarizing reflective layer, and the phase delay film are all located between the hypersurface and the second surface, and the polarizing reflective layer and the phase delay film are both located between the linear polarization film and the second surface.

19. An optical system, comprising:
a lens assembly, comprising a first surface and a second surface that are arranged in sequence along an optical axis direction of the lens assembly, and the first surface is a convex surface;
a transreflective film, located at a side of the first surface away from the second surface;
a polarizing reflective layer, located at a side of the second surface away from the first surface;
a phase delay film, located at a side of the first surface away from the transreflective film,
wherein the lens assembly further comprises a third surface, the third surface is located at the side of the second surface away from the first surface; and
the third surface comprises a first region and a second region surrounding at least a portion of the first region, wherein only the second region is provided with a microstructure, the microstructure is configured to regulate light emitted from the polarizing reflective layer.

20. The optical system according to claim 19, wherein an optical axis of the lens assembly passes through the first region.
